(19) United States
(12) Patent Application Publication
(10) Pub. No.: US 2026/0156454 A1
(43) Pub. Date: Jun. 4, 2026

(54) NETWORK INITIATED CALL UPDATES TO WIRELESS DEVICE

(71) Applicant: T-Mobile Innovations LLC, Overland Park, KS (US)

(72) Inventors: Jagannadha Anudeep Varma DATLA, Kent, WA (US); Harikishore ALLU BALAN, Lynnwood, WA (US)

(21) Appl. No.: 18/917,391

(22) Filed: Oct. 16, 2024

(51) Int. Cl. H04W 8/18; H04L 65/1104; H04W 60/04

(52) U.S. Cl. CPC H04W 8/183; H04L 65/1104; H04W 60/04

(57) ABSTRACT

Methods and systems provided herein provide for maintaining a missed and diverted call log in combination with an internet protocol (IP) multimedia subsystem (IMS) containing a telephony application server (TAS) for subscribing wireless devices. The call log is recorded with a diversion reason and a timestamp for each call. A missed call update system triggers a push of the call log to the wireless device under certain conditions.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes. Newer networks introduce new features as well as new challenges.

Currently, when a wireless device or user equipment (UE) misses a call due to one of various factors including network unreachability, dead battery, the enablement of call forwarding (CF) not reachable, CF no response, or CF unconditional, the wireless device will not receive calls directed to it. In other words, the calls are missed and diverted from the wireless device, for example to a voicemail server in the network, and are thus not received by the wireless device. The missed and diverted calls result in user call logs displayed on the wireless device being out-of-date. The failure to update is based on the fact that the updating logic is on the wireless device itself, and thus, the logic is unavailable in the above-described scenarios.

### OVERVIEW

Exemplary embodiments provided herein include a method for updating a call log for a wireless device. The method includes receiving, at a telephony application server (TAS), a subscription for a call log update from a wireless device connected to a network. The method additionally includes maintaining a call log for storing missed or diverted calls for the wireless device on the network. The method further includes determining that a condition for pushing the call log to the wireless device is satisfied and pushing the call log to the wireless device.

Embodiments disclosed herein further include a system for updating a call log with missed calls for a wireless device. The system includes a memory storing data and instructions and at least one processor executing the stored instructions to perform operations. The operations include maintaining a call log within a network for a wireless device subscribed to call log updates within the network. The operations additionally include determining a condition for pushing the call log to the wireless device is satisfied and pushing the call log to the wireless device upon determining the condition is satisfied.

In a further embodiment, a method includes sending, from a wireless device, a subscription and registration request for a missed call update system to a call session control function (CSCF). The method additionally includes receiving a subscription for the missed call update system from a telephony application server (TAS) and receiving a call log at the wireless device from the CSCF when the wireless device disconnects and reconnects to the network.

Further embodiments include non-transitory computer-readable mediums, TASs and processing nodes performing the operations described above. Further methods are provided for maintaining a call log on the network for a wireless device and providing the call log to the wireless device.

### BRIEF DESCRIPTION OF THE DRAWINGS

FIG. 1 depicts an exemplary environment for a missed call update system in accordance with an embodiment.

FIG. 2 depicts a missed call update system in accordance with an embodiment.

FIG. 3 depicts a method for operating a missed call update system in accordance with an embodiment.

FIG. 4 depicts a further exemplary method for operating a missed call update system in accordance with an embodiment.

FIG. 5 depicts an exemplary flow for subscribing a wireless device and maintaining a call log in accordance with an embodiment.

FIG. 6 depicts an exemplary flow for maintaining a call log during unconditional call forwarding and delivering the call log in accordance with an embodiment.

FIG. 7 depicts an additional exemplary method for maintaining a call log for a call forwarding no response setting and delivering the call log to the wireless device in accordance with an embodiment.

FIG. 8 depict a method for maintaining a call log and delivering the call log when a wireless device registers with a different TAS in accordance with an embodiment.

### DETAILED DESCRIPTION

In embodiments disclosed herein, a missed call update system is provided in a network in order to ensure that wireless devices are able to receive a call log containing missed and diverted calls. The missed call update system may operate in combination with an internet protocol (IP) multimedia subsystem (IMS) containing a telephony application server (TAS) and may be incorporated therein or may function as a separate processing node in combination with the IMS and TAS.

In scenarios described herein, calls are missed and diverted through one of multiple scenarios. Some of these scenarios are failure scenarios. For example, calls may be unable to reach the wireless device and may be missed due to poor network coverage or poor radio conditions. Alternatively, calls may be missed due to unavailability of the wireless device due to wireless device failure, such as software malfunction, mechanical failure, or a dead battery. These missed calls may also be diverted to another network component or may be recorded by a network component on the originating side of the communication.

Further, calls may be diverted as a result of user settings on the wireless device. For example, the wireless device may be subject to an unconditional call forwarding setting. Unconditional call forwarding is a phone feature that automatically redirects incoming calls to another phone number or service. The forwarding is “unconditional” because it occurs without any conditions such as the original number getting a call notification first or displaying the original number as ‘busy’. Further, the wireless device may be set to call forwarding no response. This occurs when unanswered calls are sent to a different number. Thus, when the wireless device receives a call that is not answered within a set time period, the call will be forwarded to another number. In all of these scenarios, the call is missed and also diverted and it is possible for the missed call update system to trigger maintenance of a call log within the network.

Accordingly, in embodiments disclosed herein, wireless devices are able to receive updates including missed and diverted calls. The updates will provide the diversion reason of the diverted call in a call log pushed to the wireless device. The diversion reasons may include, for example, unreachable wireless device, no reply from the wireless device, or an unconditional forwarding setting. The missed call update system further triggers recording a time stamp along with the missed call and the diversion reason.

After recording and maintaining the missed call log, upon detection of the wireless device as active, the missed call update system triggers a session initiation protocol (SIP) notification towards the wireless device. There are multiple ways in which the wireless device can be detected as active. First, the wireless device may perform a successful refresh registration. Alternatively, the wireless device may successfully complete a mobile originated (MO) call or successfully receive a mobile terminated (MT) call. Additionally, when the wireless device becomes active, it may request a push of the call log from the missed call update system.

In order to receive the services of the missed call update system, a subscription process may be utilized. Both the wireless device and the network, (e.g., the TAS) may subscribe to the services of the missed call update system. In order to utilize the missed call update subscription service, when an offline wireless device comes back online and there are no events towards the network, the wireless device may ask the network for the missed call update. When the wireless device comes back online and there are other events happening from the device towards the network, the missed call update system will automatically trigger the TAS to push the update for any missed call log in a SIP update towards the wireless device in a manner enabling the wireless device to decode the SIP update and display the missed calls and diversion reason along with the timestamps on the recent call log.

In addition to the systems and methods described herein, non-transitory computer-readable mediums may store the operations or the instructions for performing various methods. Further, processing nodes on the network may execute the instructions or methods. The processing node may include a processor included in TAS and/or a processor included in any controller node in the wireless network.

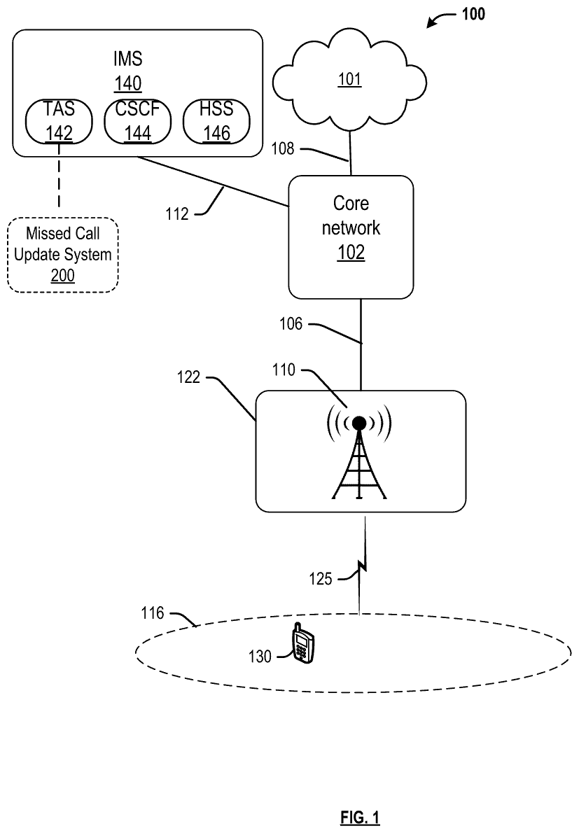

FIG. 1 depicts an exemplary environment 100 for implementing a missed call update system 200. Environment 100 comprises a communication network 101, core network 102, a radio access network (RAN) 122 including at least an access node 110, and internet protocol (IP) multimedia subsystem (IMS) 140. Wireless device 130 is located in a coverage area 116 and communicates with the access node 110 over communication link 125. Although only one wireless device 130 is shown, it should be understood that any number of wireless devices could be included. Further, the missed call update system 200 is included in or interacts with the IMS 140.

The IMS 140 is an architectural framework for delivering multimedia communications services such as voice, video and text messaging over IP networks. The IMS 140 may include multiple functions and nodes. For example the IMS 140 may include a telephony application server (TAS) 142, a call session control function (CSCF) 144, and a home subscriber server (HSS) 146. The TAS 142 is a back to back SIP user agent that maintains a call state. The TAS 142 contains service logic that provides basic call-processing services, such as, for example, digit analysis, routing, call setup, call waiting, call forwarding, etc. The CSCF 144 in the IMS 140 performs multiple roles and is implemented via servers using the SIP protocol to communicate. The HSS 146 functions as a master user database that supports IMS network entities that handle calls and sessions.

The core network 102 may include an SBA architecture, in which service-based interfaces may be utilized between control plane functions, while multiple user plane functions connect over point-to-point link. Multiple network functions within the core network 102 may communicate with and subscribe to multiple other network functions. For example, a network repository function (NRF) may maintain a record of available NFs and their supported services and allow NFs to subscribe and be notified of other NFs.

The missed call update system 200 is illustrated as communicating with or incorporated in the IMS 140. In some embodiments, the missed call update system 200 may be incorporated in or in direct communication with the TAS 142. The missed call update system 200 may further communicate with or be partially incorporated in the CSCF 144 or the HSS 146. For example, the missed call update system 200 may store call logs at the HSS 146.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with the end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106, 108, and 112 can use various communication media, such as air, space, metal, optical fiber, or some other signal propagation path including combinations thereof. Communication links 106, 108, and 112 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication links 106, 108, and 112 can be a direct link or might include various equipment, intermediate components, systems, and networks. Communication links 106, 108, and 112 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

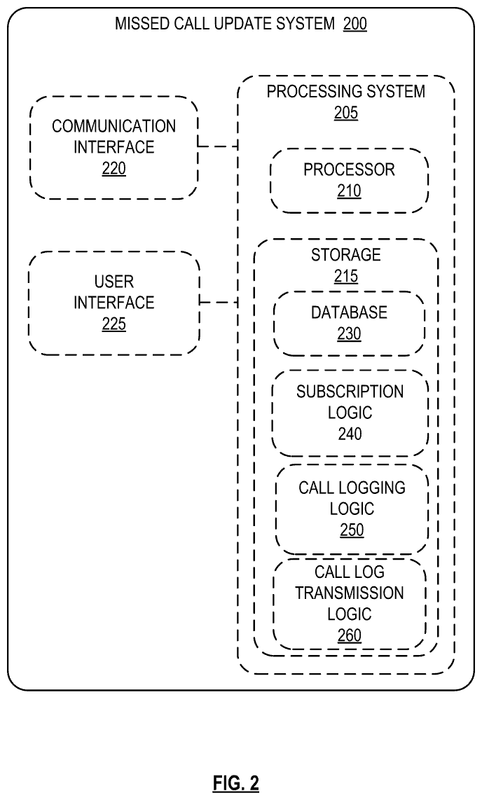

FIG. 2 illustrates a missed call update system 200 in accordance with embodiments described herein. The components described herein are merely exemplary as many different configurations for the missed call update system 200 may be implemented. The missed call update system 200 may be configured to perform the methods and operations disclosed herein to trigger maintenance of a call log for diverted or missed calls for a wireless device. The missed call update system 200 may further trigger a push of the missed call update to the wireless device when one or more conditions are satisfied. In the disclosed embodiments, the missed call update system 200 may be integrated with the IMS 140, for example with the TAS 142, or may be an entirely separate component capable of communicating with at least the TAS 142 of the IMS 140. Further, the components of the missed call update system 200 may be distributed so that one or more components are located within the IMS 140 and/or a separate processing node in communication with or integrated with the IMS 140.

The missed call update system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, subscription logic 240 may be operable to enable wireless device 130 to subscribe to the missed call update system. Call logging logic 250 may trigger call logging functions for subscribed wireless device 130. Further, call log transmission logic 260 may be operable to trigger transmission of the call logs, such as via SIP updates, to subscribed wireless devices. Database 230 may be utilized to store subscription information as well as the maintained call logs. To perform the above-described operations, the subscription logic 240, the call logging logic 250, and the call log transmission logic 260 may be executed by the processor 210 to manage the maintenance and transmission of call logs and further to update the database 230.

Processor 210 may be a microprocessor and may include hardware circuitry and/or embedded codes configured to retrieve and execute software stored in storage device 215. The missed call update system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the missed call log update system 200 and receive data or information from other system components. User interface 225 may include hardware components, such as touch screens, buttons, displays, speakers, etc. The missed call update system 200 may further include other components such as a power management unit, a control interface unit, etc.

The location of the missed call update system 200 may depend upon the network architecture. As set forth above, the missed call update system 200 may be located in the IMS 140, in a separate processing node, or in multiple locations. Alternatively, the missed call update system 200 may be an entirely discrete component. Further, although shown as a single integrated system, the functions of the missed call update system 200 may be separated and may be disposed in separate locations.

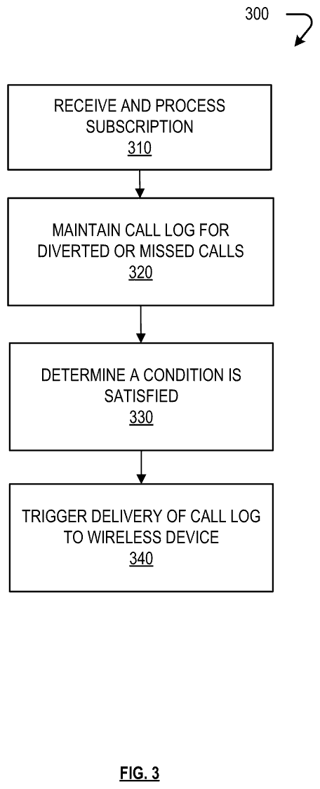

FIG. 3 illustrates a generalized exemplary method 300 for operation of the missed call log update system 200. Method 300 may be performed by a processor, for example, the processor 210 included in the missed call update system 200, or a processor in the TAS 142. For discussion purposes, as an example, method 300 is described as being performed by the processor 210 of the missed call update system 200. However, it should be understood that the steps illustrated in FIG. 3 are performed in conjunction with the TAS 142 and the processor 210 may, in fact, be incorporated in the TAS 142.

Method 300 starts in step 310, in which the processor 210 receives and processes a subscription to the services of the missed call update system 200. As will be further explained below, the wireless device 130 may subscribe to the services of the missed call update system 200 by communicating with the CSCF 144 and the TAS142. In embodiments provided herein, the subscription logic 240 is executed by the processor 210 to subscribe requesting wireless devices. After the subscription of a wireless device 130 is processed, the processor 210 may maintain the subscription in the database 230.

In step 320 the processor 210 takes step to establish and maintain a call log for the subscribed wireless device 130 when calls are diverted from the wireless device 130 or when the wireless device 130 does not receive the calls. In order to maintain the call log, the processor 210 may record call parameters (e.g., caller telephone number), a timestamp, a diversion reason, and/or other call data. The call log may be maintained, for example, in the database 230.

In step 330, the processor 210 determines that a condition has been satisfied. The condition may be related to a subscribed wireless device detected in the network. The wireless device 130 may re-register with the network, or alternatively, may successfully make a call or receive a call. As a further alternative, the condition may be a call forwarding setting that leads to an automatic push of the call log. As yet another alternative, users may send a request to the TAS 142 for the call log history when the user has been offline.

Upon determination that one of these conditions is satisfied, the processor 210 may trigger delivery of the call log to the wireless device 130 in step 340. For example, the processor 210 may cause the TAS 142 to initiate delivery of the call log to the wireless device 130 through a SIP message. In embodiments disclosed herein, the updates may be a silent push of call log information to the wireless device 130.

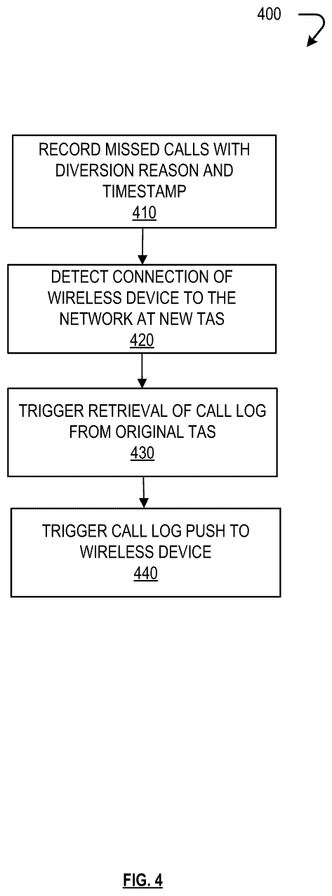

FIG. 4 depicts a further exemplary method 400 for operation of the missed call update system in accordance with an embodiment. Method 400 may be performed by any suitable processor discussed herein, for example, the processor 210 included in the missed call update system 200 or in the TAS 142. For discussion purposes, as an example, method 400 is described as being performed by the processor 210 included in the missed call update system 200, which may be wholly or partially incorporated in the IMS 140 or TAS 142.

Method 400 starts in step 410, in which the processor 210 records missed calls for subscribed wireless devices with a diversion reason and a timestamp. From the recorded missed calls, the processor 210 assembles a call log for the wireless device 130. The processor 210 may cause the call log to be stored, for example, in the database 230 or alternatively in the HSS 146.

In step 420, the processor 210 detects a connection of the wireless device 130 at a new TAS. For example, the user of the wireless device 130 may not be registered with the network during a cross country flight. Once the flight lands, when the wireless device 130 becomes re-connected to the network, the wireless device 130 will connect to a different TAS in a different geographic location.

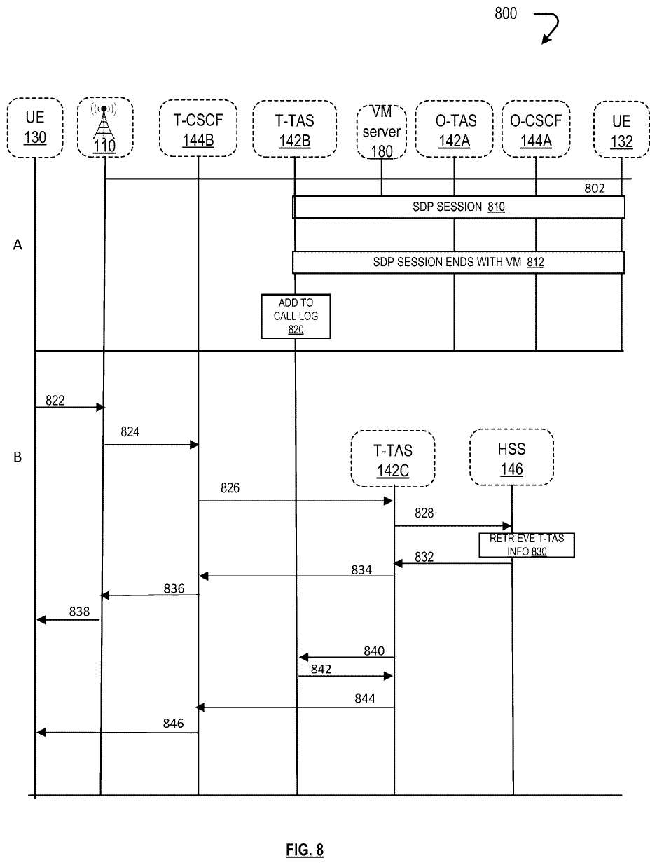

Thus, in step 430, the processor 210 triggers retrieval of the call log maintained by the original TAS 142. The process of retrieving the call log will be further described below with reference to FIG. 8

Finally, in step 440, the processor 210 triggers a call log push to the wireless device 130. The call log push may be triggered from the new TAS to the wireless device 130 through SIP messaging.

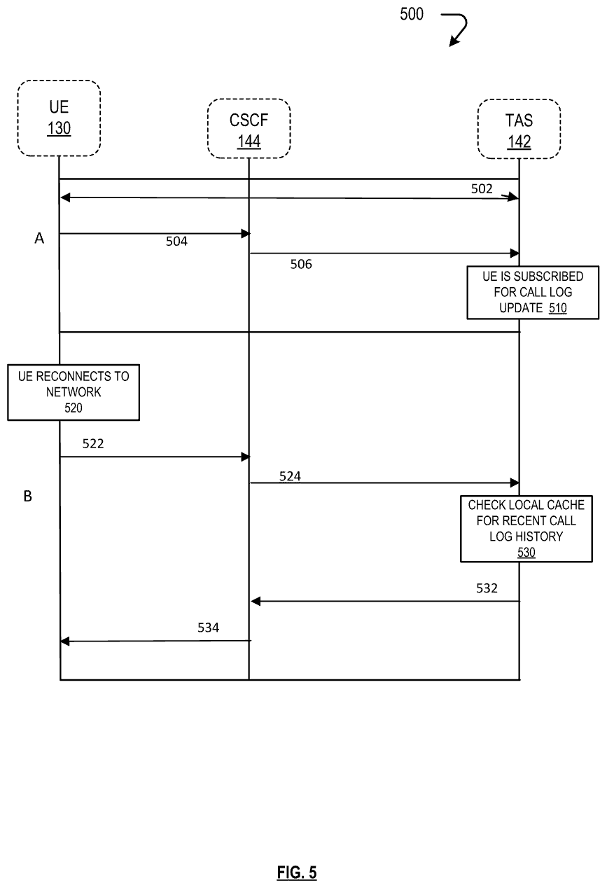

FIG. 5 depicts a method 500 for illustrating interactions between the above-described components during a subscription process A and during a call log push B. Interacting components shown include the UE 130, the CSCF 144 and the TAS 142. However, it should be understood that the missed call update system 200 may either be incorporated in the TAS 142 or in communication with the TAS 142 in order to trigger the various interactions shown in FIG. 5. Further, base stations and other network components may be involved in the subscription and log delivery processes, but are omitted for simplification.

Part A illustrates a subscription process for the wireless device 130. In step 502, the wireless device 130 and the TAS 142 engage in an IMS initial registration flow as it currently exists or as it may evolve in the future. In step 504, the UE 130 sends a subscription and registration request for the missed call update system 200 to the CSCF 144. The CSCF 144 processes and forwards the request in step 506 to the TAS 142. In step 510, the missed call update system 200 triggers the TAS 142 to subscribe the wireless device 130 for the missed call update system services.

Part B illustrates the process of pushing a call log maintained by the missed call update system 200 to the wireless device 130. In step 520, the wireless device 130 reconnects to the network. In step 522, the wireless device sends a SIP request for the call log to the CSCF 144. The CSCF 144 forwards the SIP request for the call log to the TAS 142 in step 524. In step 530, the missed call update system 200 triggers the TAS to check the local cache, such as the database 130, for recent call log history for the wireless device 130. In step 532, the missed call update system 200 triggers the TAS 142 to push the call log to the CSCF 144. The CSCF 144 pushes the log to the wireless device 130 in step 440.

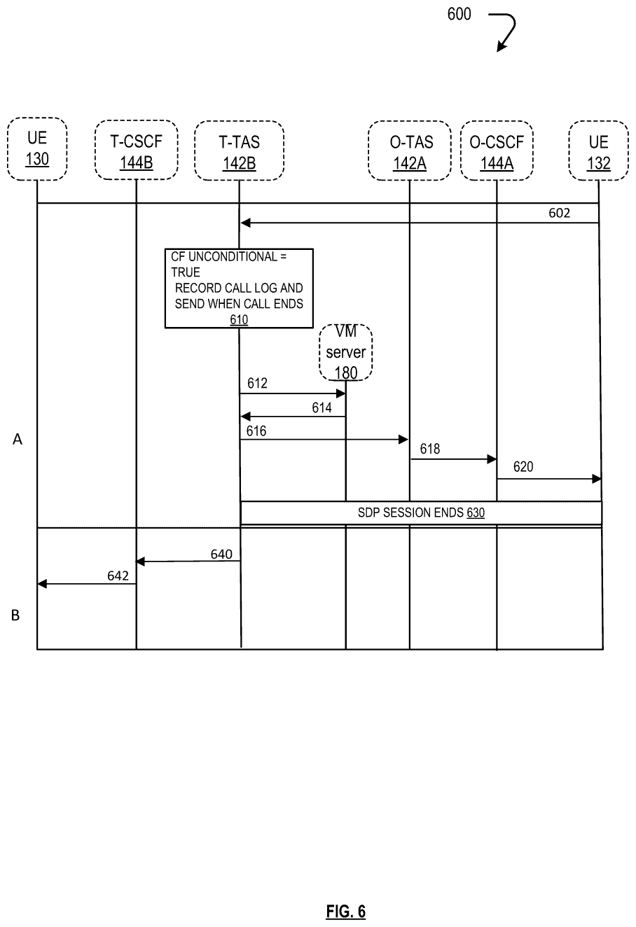

FIG. 6 is a method 600 depicting interaction between the above-described components in a scenario in which the wireless device 130 utilizes an unconditional call forwarding setting. The interaction of FIG. 6 assumes that the UE 130 has subscribed for the services of the missed call update system 200, which may be incorporated in or in communication with the terminating TAS (T-TAS) 142B. Part A illustrates interaction between the components when the wireless device 130 is subscribed to the missed call update system 200, has unconditional call forwarding configured, and receives a call from another wireless device 132. Further, the interaction illustrated may be a simplification as additional network components may be involved in the illustrated scenario.

Part A of the illustrated scenario begins when a wireless device 132 attempts to call the wireless device 130 in step 602. This step involves the sending of a SIP invite from the wireless device 132 to the T-TAS 142B. The SIP invite may be sent through the originating CSCF (O-CSCF) 144A and an O-TAS 142A to the T-TAS 142B. In step 610, the missed call update system 200 or the T-TAS 142B determines that the wireless device 130 has unconditional call forwarding configured and therefore triggers recording of missed calls in the call log for the wireless device 130. The T-TAS 142B connects with a voicemail server 180 in step 612 and receives a SIP invite in step 614. Through steps 616, 618, and 620, the wireless device 132 is able to leave a voicemail for the wireless device 130 in a session description protocol (SDP) session. The SDP session ends in step 630.

Part B of the illustrated scenario occurs when the wireless device 130 re-registers with the network or terminates unconditional call forwarding, or simply may occur automatically per the terms of the subscription of the wireless device 130 with the missed call update system 200. In step 640, the missed call update system 200 may trigger the push of the call log from the T-TAS 142B to the T-CSCF 144B. The T-CSCF 144B may then push the call log to the wireless device 130 in step 642.

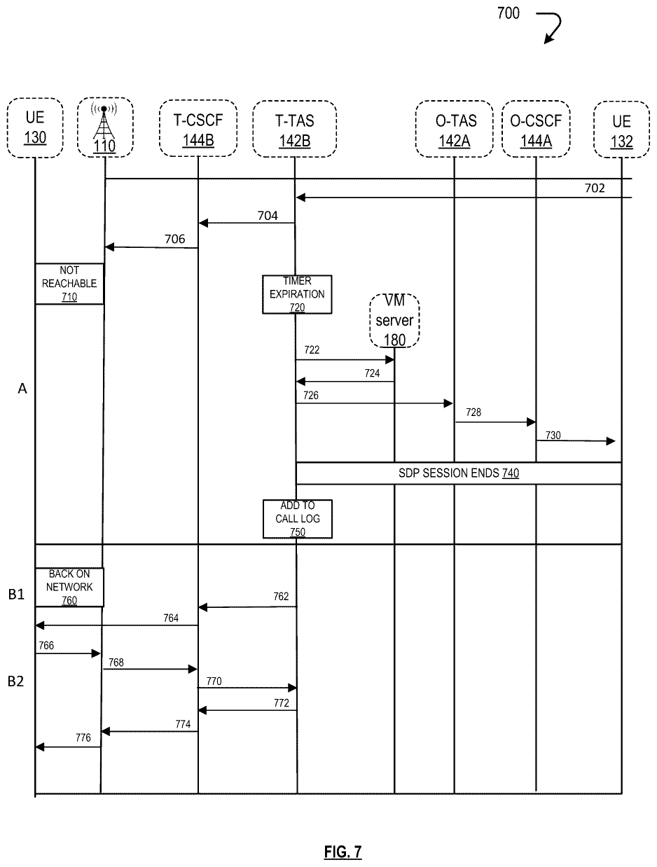

FIG. 7 is a flow diagram 700 illustrating operation of the missed call update system 200 when the wireless device 130 has call forwarding set when the user is unable to answer an incoming call within a set time period. Part A illustrates a call handling and call logging process and Parst B1 and B2 illustrate delivery of the call log to the wireless device 130. While a limited number of network components are illustrated, additional or fewer network components may be involved in the interaction.

In Part A, the scenario begins in step 702 when the wireless device 132 attempts to call the wireless device 130. The wireless device 132 sends a SIP invite through the O-CSCF 144A and the O-TAS 142A to the T-TAS 142B. The T-TAS 142B forwards the SIP invite in step 704 to the T-CSCF 144B. The T-CSCF 144B forwards the SIP invite to the access node 110 in step 706. In step 710, due to no response by the UE 130, the UE 130 is deemed not reachable and a timer expires at the T-TAS 142B in step 720.

Upon expiration of the timer in step 720, the T-TAS 142B sends a SIP invite to the voicemail server 180 in step 722. The voicemail server responds in step 724 and a voicemail is left through interaction of the T-TAS 142B, O-TAS 142A, O-CSCF 144A, and wireless device 132 in steps 726, 728, and 730 during an SDP session.

In step 740, the SDP session ends. Upon the ending of the session, the missed call update system 200 triggers the T-TAS 142 to record the call, the diversion reason, and the time-stamp and add the recorded information to the call log in step 750. The call log may be stored, for example, at the missed call update system 200.

In parts B1 and B2, the missed call update system 200 ensures that the call log is forwarded to the wireless device 130. In Part B1, In step 760, the missed call update system 200 determines that the wireless device 130 is back on the network based on activity triggered towards the IMS, for example through re-registration, or completed calls subsequent to the recording of the call log. In step 762, the T-TAS 142B sends a SIP update including the recorded call log to the T-CSCF 144B. The T-CSCF 144B sends the SIP update to the wireless device 130 via the access node 110 in step 764.

In part B2, the wireless device joins the network silently without any activity toward the IMS 140. In this instance, wireless device 130 sends a SIP request in step 766 to the access node 110, which forwards the SIP request in step 768 to the T-CSCF 144B, which forwards the SIP request to the T-TAS 142B in step 770.

In response to the SIP request of step 770, the T-TAS 142B is prompted by the missed call update system 200 to send a SIP response with the stored call log in step 772 to the T-CSCF 144B. The T-CSCF 144B forwards the SIP response to the access node 110 in step 774, which forwards the SIP response to the wireless device 130 in step 776.

FIG. 8 is a flow diagram 800 illustrating interaction between the components when the user of the wireless device 130 re-enters the network and switches to a different TAS. It is assumed that the wireless device 130 has subscribed to the missed call update system 200. Fewer or additional network components may be involved in the interaction.

Part A illustrates an SDP session 810 in which a wireless device 132 attempts to connect with the wireless device 130. Because the wireless device 130 is unavailable, e.g., switched off, or in bad coverage, the SDP session ends with a voicemail in step 812. In step 820, the missed call update system 200 triggers the T-TAS 142B to add the missed call along with a diversion reason and time stamp to the call log.

In part B, the wireless device 130 re-enters the network by registering on a different TAS, which T-TAS 142C. Specifically, in step 822, the wireless device 130 sends a SIP registration and subscribe message to the access node 110, which forwards the message to the T-CSCF 144B in step 824. The T-CSCF 144B forwards the message to the new T-TAS 142C in step 826. In step 828, the new T-TAS 142C sends a diameter subscribe notification request (SNR) message to the HSS 146. In step 830, the HSS 146 retrieves T-TAS info and forwards the recorded call log from the original T-TAS 142B to the new T-TAS 142C in step 832 through a diameter subscribe notification answer (SNA) response. The T-TAS 142C directs a SIP response towards the wireless device 130 in step 834, which is transmitted from the T-CSCF 144B to the cell tower 110 in step 836 and to the wireless device in step 838.

In response to the diameter SNA of step 832, the T-TAS 142C is triggered by the missed call update system 200 to send an HTTP request to the T-TAS for the call log history in step 840. In step 842, the T-TAS 142B responds with the call log history. In step 844, the T-TAS 142C sends the call log history to the T-CSCF 144B, which forwards the SIP update including the call log to the wireless device in step 846.

Accordingly, as set forth above, embodiments provide for missed call update logs to be maintained by the network and provided to wireless devices upon satisfaction of certain conditions. In some embodiments, methods and interactions 300, 400, 500, 600, 700, and 800 may include additional steps or operations. Additionally, the various scenarios may include interactions between additional components, which are omitted for ease of explanation. Furthermore, the methods may include steps shown in each of the other methods. Additionally, the order of steps shown is merely exemplary and the steps may be re-ordered as appropriate. As one of ordinary skill in the art would understand, the methods and interactions 300, 400, 500, 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising;
receiving, at a telephony application server (TAS), a subscription for a call log update from a wireless device connected to a network;
maintaining a call log for the wireless device for missed and diverted calls;
determining a condition for pushing the call log to the wireless device is satisfied; and
pushing the call log to the wireless device.

2. The method of claim 1, wherein the condition includes recording a voicemail for the wireless device when the wireless device is set to unconditional call forwarding.

3. The method of claim 1, wherein the condition includes receiving notification that the wireless device is re-registered with the network.

4. The method of claim 1, wherein the condition includes registration of the wireless device with a different TAS.

5. The method of claim 1, wherein the condition includes successful receipt of a mobile terminated (MT) call by the wireless device or successful completion of a mobile originated (MO) call by the wireless device.

6. The method of claim 1, further comprising maintaining the call log when the wireless device is unreachable.

7. The method of claim 6, wherein the wireless device is unreachable due to a network failure, poor radio conditions, or wireless device failure.

8. The method of claim 1, further comprising recording missed calls for the call log with a diversion reason, wherein the diversion reason is one of an unreachable wireless device, no reply from the wireless device, and call forwarding set by the wireless device.

9. The method of claim 1, wherein maintaining the call log further comprises recording missed calls with a timestamp.

10. The method of claim 1, further comprising pushing the call log to the wireless device as a session initiation protocol (SIP) message.

11. The method of claim 10, wherein the pushed call log comprises a timestamp and a diversion reason for each missed call.

12. A system comprising:
a memory storing data and instructions; and
a processor accessing the stored instructions to perform operations including:
maintaining a call log for a wireless device subscribed to call log updates for missed or diverted calls;
determining a condition for pushing the call log to the wireless device is satisfied; and
pushing the call log to the wireless device.

13. The system of claim 12, the operations further comprising recording missed calls for the call log with a diversion reason, wherein the diversion reason is one of an unreachable wireless device, no reply from the wireless device, and unconditional forwarding set by the wireless device.

14. The system of claim 12, wherein maintaining the call log further comprises recording missed calls with a timestamp.

15. The system of claim 12, wherein the call log is pushed to the wireless device as a session initiation protocol (SIP) message.

16. The system of claim 12, wherein the pushed call log comprises a diversion reason and a timestamp for each missed call.

17. A method comprising:
sending, from a wireless device, a subscription and registration request for a missed call update system to a call session control function (CSCF);
receiving a subscription for the missed call update system from a telephony application server (TAS); and
receiving a call log at the wireless device from the CSCF when the wireless device disconnects and reconnects to the network.

18. The method of claim 17, wherein the call log is maintained when the wireless device is unreachable.

19. The method of claim 17, further comprising sending a session initiation protocol (SIP) request for the call log from the wireless device to the CSCF.

20. The method of claim 17, further comprising establishing reconnection by the wireless device by successfully receiving a mobile terminated (MT) call by the wireless device or successfully completing of a mobile originated (MO) call by the wireless device.
